(19) United States
(12) Patent Application Publication
(10) Pub. No.: US 2017/0374243 A1
(43) Pub. Date: Dec. 28, 2017

(54) METHOD OF REDUCING LATENCY IN A SCREEN MIRRORING APPLICATION AND A CIRCUIT OF THE SAME

(71) Applicant: Sigma Designs, Inc., Fremont, CA (US)

(72) Inventor: Vincent Trinh, Pleasanton, CA (US)

(73) Assignee: Sigma Designs, Inc., Fremont, CA (US)

(21) Appl. No.: 15/189,003

(22) Filed: Jun. 22, 2016

(51) Int. Cl. H04N 5/08; H04N 7/18

(52) U.S. Cl. CPC H04N 5/08; H04N 7/18

(57) ABSTRACT

A method of reducing latency in a screen mirroring application, comprises receiving, by a receiver from a source device, an audio stream output by the source device; receiving, by the receiver from a processor, a video stream displayed on a first screen at the source device; receiving, by a receiver, audio and video time stamps; discarding, by a controller, the audio and video time stamps; outputting, by a decoder to a second display, the audio stream and video streams independent of timing indicated by the audio and video time stamps.

### TECHNICAL FIELD

The present invention relates to screen mirroring, and more particularly, but not limited to a method of reducing latency in a screen mirroring application and a circuit of the same.

### BACKGROUND

If a video has to synchronize (sync) to audio or some other clock, possible display delays may be introduced. Therefore, it is desired to design a method and circuit that reduces display delays.

### SUMMARY

In one aspect of the invention, a method a method of reducing latency in a screen mirroring application, comprises receiving, by a receiver from a source device, an audio stream output from a source device; receiving, by the receiver from a processor, a video stream displayed on a first screen at the source device; receiving, by a receiver, from a processor, audio and video time stamps; discarding, by a controller, the audio and video time stamps; outputting, by a decoder to a second display, the audio stream and video streams independent of timing indicated by and audio and video time stamps.

In another aspect of the invention, a circuit for reducing latency in a screen mirroring application, comprises a receiver configured to receive, from a source device, an audio stream output by the source device; to receive, from a processor, a video stream displayed on a first screen at the source device; and to receive, from a processor, audio and video time stamps; a controller configured to discard both the audio and video time stamps; a decoder is configured to output to a second display, both the audio stream and the video streams independent of timing indicated by and audio and video time stamps.

### BRIEF DESCRIPTION OF THE DRAWINGS

The present invention is illustrated in an exemplary manner by the accompanying drawings. The drawings should be understood as exemplary rather than limiting, as the scope of the invention is defined by the claims. In the drawings, the identical reference signs represent the same elements.

FIG. 1 is a diagram illustrating a network environment according to an embodiment of the invention.

FIG. 2 is a schematic illustration of one embodiment of a computer system 200 that can perform the methods and techniques provided by various other embodiments of the invention.

FIG. 3 is a flowchart illustrating a method 300 of reducing latency according to an embodiment of the invention.

FIG. 4 is a block diagram illustrating a circuit according to an embodiment of the invention.

### DETAILED DESCRIPTION

References in this description to “an embodiment”, “one embodiment”, or the like, mean that the particular feature, function, structure or characteristic being described is included in at least one embodiment of the present invention. Occurrences of such phrases in this specification do not necessarily all refer to the same embodiment. On the other hand, such references are not necessarily mutually exclusive either.

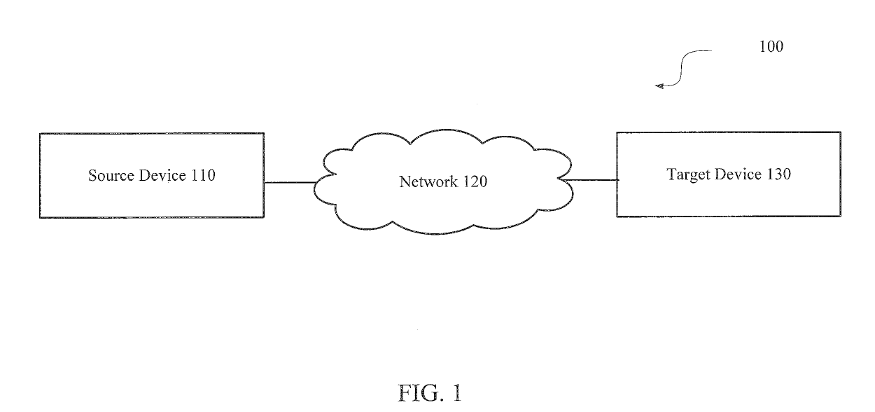

FIG. 1 is a diagram illustrating a network environment 100 according to an embodiment of the invention. The network environment 100 comprises a source device 110, a network 120 and a target device 130. The source device 110 communicates with the target device 130 via the network 120. The network 120 may be a wired or wireless network. In an embodiment of the invention, the network 120 is wireless network to facilitate flexible connection between the source device 110 and the target device 130.

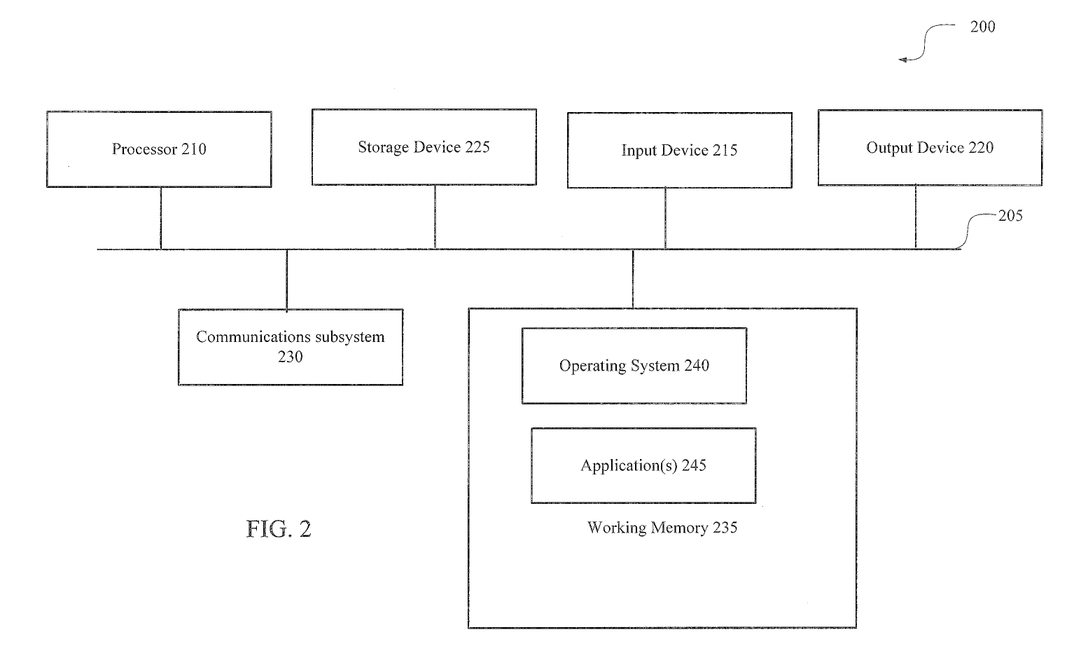

FIG. 2 is a schematic illustration of one embodiment of a computer system 200 that can perform the methods and techniques provided by various other embodiments, as described herein, and/or can function as a video communication device. It should be noted that FIG. 2 is meant only to provide a generalized illustration of various components, of which one or more (or none) of each may be utilized as appropriate. FIG. 2, therefore, broadly illustrates how individual system elements may be implemented in a relatively separated or relatively more integrated manner.

The computer system 200 is shown comprising hardware elements that can be electrically coupled via a bus 205 (or may otherwise be in communication, as appropriate). The hardware elements may include one or more processors 210, including without limitation one or more general-purpose processors and/or one or more special-purpose processors (such as digital signal processing chips, graphics acceleration processors, and/or the like); one or more input devices 215 (or interfaces therefore), which can include without limitation a video source such as a camera, a touch screen, a mouse, a keyboard and/ or the like; and one or more output devices 220 (or interfaces therefore), which can include without limitation a video sink such as a display device, a printer and/or the like.

The computer system 200 may further include (and/or be in communication with) one or more storage devices 225, which can comprise, without limitation, local and/or network accessible storage, and/or can include, Without limitation, a disk drive, a drive array, an optical storage device, solid-state storage device such as a random access memory (“RAM”) and/or a read-only memory (“ROM”), which can be programmable, flash-updatable and/or the like. Such storage devices may be configured to implement any appropriate data stores, including without limitation, various file systems, database structures, and/or the like.

The computer system 200 might also include a communications subsystem 230, which can include without limitation a modem, a network card (wireless or wired), an infrared communication device, a wireless communication device and/or chipset (such as a Bluetooth™ device, an 802.11 device, a Wi-Fi device, a WiMAX device, a WLAN device, cellular communication facilities, etc.), and/or the like. The communications subsystem 230 may permit data to be exchanged with a network (such as the network described below, to name one example), with other computer systems, and/or with any other devices described herein. In many embodiments, the computer system 200 will further comprise a working memory 235, which can include a RAM or ROM device, as described above.

The computer system 200 also may comprise software elements, shown as being currently located within the working memory 235, including an operating system 240, device drivers, executable libraries, and/or other code, such as one or more application programs 245, which may comprise computer programs provided by various embodiments, and/or may be designed to implement methods, and/or configure systems, provided by other embodiments, as described herein. Merely by way of example, one or more procedures described with respect to the techniques and method discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 225 described above. In some cases, the storage medium might be incorporated within a computer system, such as the system 200. In other embodiments, the storage medium might be separate from a computer system (i.e., a removable medium, such as a compact disc, etc.), and/or provided in an installation package, such that the storage medium can be used to program, configure and/or adapt a general purpose computer with the instructions/code stored thereon. These instructions might take the form of executable code, which is executable by the computer system 200 and/or might take the form of source and/or installable code, which, upon compilation and/or installation on the computer system 200 (e. g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 200) to perform methods in accordance with various embodiments of the invention. According to a set of embodiments, some or all of the procedures of such methods are performed by the computer system 200 in response to one or more processors 210 executing one or more sequences of one or more instructions (which might be incorporated into the operating system 240 and/or other code, such as an application program 245, processing block, etc.) contained in the working memory 235. Such instructions may be read into the working memory 235 from another computer readable medium, such as one or more of the storage device(s) 225.

Merely by way of example, execution of the sequences of instructions contained in the working memory 235 might cause the processor(s) 210 to perform one or more procedures of the methods described herein.

The terms “machine readable medium” and “computer readable medium,” as used herein, refer to any medium that participates in providing data that causes a machine to operation in a specific fashion. In an embodiment implemented using the computer system 200, various computer readable media might be involved in providing instructions/code to processor(s) 210 for execution and/ or might be used to store and/or carry such instructions/code (e.g., as signals).

In many implementations, a computer readable medium is a non-transitory, physical and/or tangible storage medium. Such a medium may take many forms, including but not limited to non-volatile media, volatile media, and transmission media. Non-volatile media includes, for example, optical and/or magnetic disks, such as the storage device(s) 225.

Volatile media includes, without limitation, dynamic memory, such as the working memory 235. Transmission media includes, without limitation, coaxial cables, copper wire and fiber optics, including the wires that comprise the bus 205, as well as the various components of the communication subsystem 230 (and/or the media by which the communications subsystem 230 provides communication with form of waves (including without limitation radio, acoustic and/or light Waves, such as those generated during radio wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium With patterns of holes, a RAM, a PROM, an EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 210 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 200. These signals, which might be in the form of electromagnetic signals, acoustic signals, optical signals and/or the like, are all examples of carrier waves on which instructions can be encoded, in accordance with various embodiments.

The communications subsystem 230 (and/or components thereof) generally will receive the signals, and the bus 205 then might carry the signals (and/or the data, instructions, etc. carried by the signals) to the working memory 235, from which the processor(s) 205 retrieves and executes the instructions. The instructions received by the working memory 235 may optionally be stored on a storage device 225 either before or after execution by the processor(s) 210.

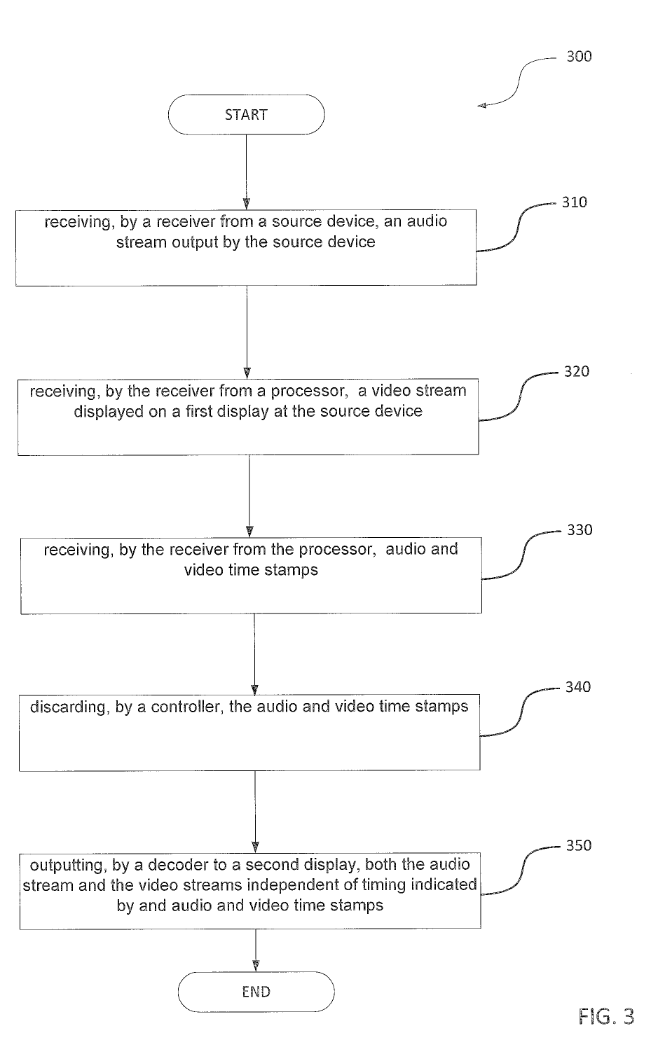

FIG. 3 is a flowchart illustrating a method 300 of reducing latency according to an embodiment of the invention.

The method 300 relates to reducing latency in a screen mirroring application. A screen mirror application may comprise Wireless Display (Widi) by Intel®, or “Miracast” by the WiFi alliance. The screen mirror application enables users to stream music, movies, photos, videos, apps and etc. wirelessly from a compatible computer to a compatible High Definition TV (HDTV) or through the use of an adapter with other HDTVs. In this scenario, the computer is called a source device, while an HDTV is called a target device. A source device may comprise a desktop, a laptop, a tablet, a notebook, or a mobile device, such as a mobile phone, a smartphone, a handheld device, PDAs, etc. A target device may comprise a TV, a desktop display, a laptop, a tablet, a notebook, a projector, or a mobile device. In the case of a mirroring application, a constant video stream is sent. In an embodiment of the invention, the video is displayed on the source device and target device simultaneously. In an embodiment of the invention, the audio is played by the target device only. Alternatively, the audio is played on both the source device and the target device.

The method 300 comprises, receiving in block 310, by a receiver from a source device, an audio stream output by the source device; receiving in block 320, by the receiver from a processor, a video stream displayed on a first screen at the source device; receiving in block 330, by the receiver from the processor, audio and video time stamps; discarding in block 340, by a controller, the audio and video time stamps; outputting in block 350, by a decoder to a second display, the audio stream and the video streams independent of timing indicated by the audio and video time stamps. In an embodiment, the audio stream is outputted by the source device and received by the receiver of a target device. The target device may be remote from the source device. By discarding the audio and video time stamps, the method 300 may decode as soon as when the data (audio or video) arrive. For example, when both the audio and video data are compressed, the method 300 may decompress the compressed audio and video data as soon as when they arrive. Alternatively, if the audio data are uncompressed and the video data are compressed, the method 300 may decompress the compressed video data as soon as when they arrive, and render the audio data as soon as when they arrive. The issue of out-out-sync is considered not to be an issue, because the audio and video are assumed to be multiplexed in a way such that the audio and video are inherently in sync. It may not be in perfect sync, but good enough so that a viewer could not notice (normally the av sync must be out of sync by at least 3 frames before a viewer would notice). Basically the idea is that the multiplex of the audio and video into a single stream is done in a manner something like this: “avavavavava,” where “a” is an audio packet with the duration of approximate 1 picture time, and “v” is a video picture. Because “a” may be compressed, it may not be exactly the duration of one video frame, so once in a while we might have: “aavavavav” or “avavavva.” If the multiplexer did something like this, the audio and video would be inherently in “good enough” sync. Normally, a live encoder (as in the case of a mirroring product) would do something like this anyway.

In an embodiment, the audio stream is played on the speaker of the target device only, and the audio stream is mute on the source device, so as to avoid echo. The audio and video streams are multiplexed into a single stream, and the time stamps are embedded inside this single stream. For example, a MPEG transport stream is used. The MPEG transport stream (MPEG-TS, MTS or TS) is a standard container format for transmission and storage of audio, video, and Program and System Information Protocol (PSIP) data. It may be used in broadcast systems such as Digital Video Broadcasting (DVB), Advanced Television System Committee (ATSC) and IPTV.

The audio and video timestamps are normally just integers. In the case of a transport stream, they are 33 bit integers with a resolution of 90 kHz, or 90000 ticks/second or 90 kHz.

The format and location of the audio and video timestamps are defined by the specification of how the streams were multiplexed together. In the case of a transport stream, those skilled in the art can refer to documented international standards, such as ISO/IEC standard 13818-1 or ITU-T Rec. H.222.0, H.222/H.262 (aka MPEG-2).

If the depth of audio frame FIFO is one frame, for uncompressed audio frame, the one frame can be considered to be the time for one video frame. For example, the video frame is encoded at 60 frames per second, and one audio frame can be considered as the duration of one video frame. In this example, 1/60^{th} of a second or 16.7 ms.

Alternatively, the audio and video time stamps include audio and video presentation time stamps (PTS). The PTS is a timestamp metadata field in an MPEG transport stream or MPEG program stream that is used to achieve synchronization of programs' separate elementary streams (for example Video, Audio, Subtitles) when presented to the viewer. The PTS is given in units related to a program's overall clock reference, either Program Clock Reference (PCR) or System Clock Reference (SCR), which is also transmitted in the transport stream or program stream.

Presentation time stamps have a resolution of 90 kHz, suitable for the presentation synchronization task. The PCR or SCR has a resolution of 27 MHz which is suitable for synchronization of a decoder's overall clock with that of the usual remote encoder, including driving TV signals such as frame and line sync timing, color sub carrier, etc.

A transport stream may contain multiple programs and each program may have its own time base. The time bases of different programs within a transport stream may be different. Because PTSs apply to the decoding of individual elementary streams, they reside in the PES packet layer of both the transport streams and program streams. End-to-end synchronization occurs when encoders save time stamps at capture time, when the time stamps propagate with associated coded data to decoders, and when decoders use those time stamps to schedule presentations. According to an embodiment of the invention, if a decoder receives the PTS, it will not use the PTS for synchronization. Instead, it will ignore it.

According to embodiments of the invention, the audio and video time stamps include Audio to video synchronization.

Audio to video synchronization (also known as audio video sync, audio/video sync, AV-sync, or lip sync) refers to the relative timing of audio (sound) and video (image) parts during creation, post-production (mixing), transmission, reception and play-back processing. When sound and video have a timing related cause and effect, AV-sync can be an issue in television, videoconferencing, or film.

Alternatively, the audio stream and the video stream are compressed data, wherein outputting, in block 350, by the decoder, the audio stream and the video streams comprises decoding and outputting the compressed data.

Alternatively, the screen mirroring application comprises Wireless Display, or Miracast.

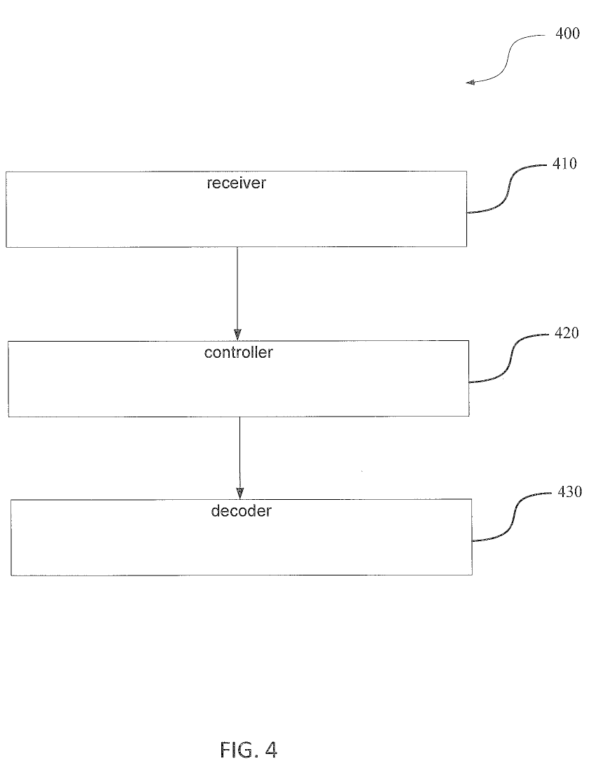

FIG. 4 is a block diagram illustrating a circuit 400 according to an embodiment of the invention. The circuit 400 for reducing latency in a screen mirroring application, comprises a receiver 410, a controller 420, and a decoder 430. The receiver 410 receives, from a source device, an audio stream output from the source device; receives, from a processor, a video stream displayed on a first screen at the source device; and receives, from the processor, audio and video time stamps. The controller 420 discards the audio and video time stamps. The decoder 430 outputs to a second display, the audio stream and the video streams independent of timing indicated by the audio and video time stamps.

Alternatively, the audio and video time stamps include audio and video presentation time stamps (PTS).

Alternatively, the audio and video time stamps include AV-sync.

Alternatively, the audio stream and the video stream are compressed data, wherein the decoder is further configured to decode and outputting the compressed data.

Alternatively, the screen mirroring application comprises Wireless Display, or Miracast.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A method of reducing latency in a screen mirroring application, comprising:
receiving, by a receiver from a source device, an audio stream output by the source device;
receiving, by the receiver from a processor, a video stream displayed on a first display at the source device;
receiving, by the receiver, from the processor, audio and video time stamps;
discarding, by a controller, the audio and video time stamps;
outputting, by a decoder to a second display, the audio stream and video streams independent of timing indicated by the audio and video time stamps.

2. The method of claim 1, wherein the audio and video time stamps include audio and video presentation time stamps (PTS).

3. The method of claim 1, wherein the audio and video time stamps include AV-sync.

4. The method of claim 1, wherein the audio stream and the video stream are compressed data, wherein outputting, by the decoder, the audio stream and video streams comprises
decoding and outputting the compressed data.

5. The method of claim 1, wherein the screen mirroring application comprises Wireless Display, or Miracast.

6. A circuit for reducing latency in a screen mirroring application, comprising:
a receiver configured
to receive, from a source device, an audio stream output by the source device;
to receive, from a processor, a video stream displayed on a first screen at the source device; and
to receive, from a processor, audio and video time stamps;
a controller configured to discard the audio and video time stamps;
a decoder is configured to output to a second display, the audio stream and video streams independent of timing indicated by the audio and video time stamps.

7. The circuit of claim 6, wherein the audio and video time stamps include audio and video presentation time stamps (PTS).

8. The circuit of claim 6, wherein the audio and video time stamps include AV-sync.

9. The circuit of claim 6, wherein the audio stream and the video stream are compressed data, wherein the decoder is further configured to decode and outputting the compressed data.

10. The circuit of claim 6, wherein the screen mirroring application comprises Wireless Display, or Miracast.
